(19) United States
(12) Patent Application Publication
(10) Pub. No.: US 2017/0305420 A1
(43) Pub. Date: Oct. 26, 2017

(54) ENABLING A HIGHLY AUTOMATED DRIVING FUNCTION

(71) Applicant: DAIMLER AG, Stuttgart (DE)

(72) Inventors: Jens DESENS, Stuttgart (DE); Martin HEIN, Bad Liebenzell (DE); Armin JOOS, Stuttgart (DE); Uli KOLBE, Stuttgart (DE); Rainer LAUX, Filderstadt (DE); Volker OLTMANN, Calw (DE)

(21) Appl. No.: 15/513,215

(22) PCT Filed: Jul. 11, 2015
(86) PCT No.: PCT/EP2015/001423

§ 371 Date: Mar. 22, 2017

(30) Foreign Application Priority Data
Sep. 24, 2014 (DE) 10 2014 014 120.9

(51) Int. Cl. B60W 30/12; G05D 1/02; G05D 1/00

(52) U.S. Cl. CPC B60W 30/12; G05D 1/0278; G05D 1/0061; G05D 1/0088; G05D 1/0238

(57) ABSTRACT

A method for autonomous operation of a vehicle on a driving route ahead permits autonomous operation of the vehicle is only permitted if one or a group of conditions is/are fulfilled for a predetermined route length of the driving route ahead. The conditions include: there is a structural separation on at least one side of a current travel path of the vehicle; a driving lane of the vehicle has a minimum lane width; there are no humps and dips substantially limiting the range of environmental detection sensors; the number of driving lanes does not change; there are no tunnels; there are no buildings on the travel path; there are no motorway junctions; a radius of curvature of the driving lane of the vehicle is larger than a predetermined limit value; there are no traffic disruptions; there are no traffic reports about dangerous situations; and there are no traffic reports about the presence of roadworks.

### BACKGROUND AND SUMMARY OF THE INVENTION

Exemplary embodiments of the invention relate to a method for autonomous operation of a vehicle, an assistance system for autonomous operation of a vehicle, and a vehicle having such an assistance system.

Generic methods and assistance systems are known from prior art. German patent document DE 10 2012 016 802 A1 thus discloses a method for controlling a vehicle system, which is designed for autonomous operation of a motor vehicle. According to the disclosure, location information describing a current position of the motor vehicle, as well as at least one piece of permission information containing location-specific information about the permissibility of the autonomous operation of the motor vehicle, are used to determine settings information for the vehicle system. In addition, at least one operation parameter of the vehicle system is selected depending on the settings information. Clearly, in the method known in prior art, the settings information for the vehicle system is only dependent on local location information that, however, is not detailed to an extent necessary for autonomous driving operation of a vehicle. In particular, the publication corresponding to prior art does not provide any information about the infrastructural requirements for an autonomous driving operation of a vehicle.

Exemplary embodiments of the invention are directed to an improved method for autonomous operation of a motor vehicle.

According to one aspect of the invention a method for autonomous operation of a vehicle on a driving route ahead by the autonomous operation of the vehicle will only be permitted if at least one of the following conditions is fulfilled for a predetermined route length of the driving route ahead.

An exemplary condition is to only permit the autonomous operation of the vehicle if a structural separation, for example in the form of crash barriers or guide walls, is present on at least one side, preferably on both sides of a current travel path of the vehicle. This aspect limits the use of autonomous operation of the vehicle to motorways and mostly highways developed with multiple lanes.

As a further condition, autonomous operation of the vehicle is only permitted when a driving lane of the vehicle has a minimum lane width, whereby it is ensured that minimum distance tolerances to adjacent driving lanes can also be adhered to during autonomous operation of the vehicle.

As a further condition, the number of driving lanes must not change during autonomous operation. In this way, hazardous points, such as local lane merging areas or roadworks, are specifically exempt from autonomous operation of the vehicle.

As a further condition, there must be no tunnel present for autonomous operation of the vehicle because even a tunnel is a local hazard point and, in addition, not all systems required for autonomous operation of the vehicle are available in a tunnel, wherein this aspect is particularly applicable to telematics-based systems, in particular for data transmissions to backend systems.

As a further condition, autonomous operation of the vehicle should only be possible if no building such as a toll station, for example, is present on the road, since these infrastructural facilities are also local hazard points.

As a further condition, autonomous operation of the vehicle must be stopped when a motorway junction is present, wherein the aspect of a local hazard point, along with a change in the number of driving lanes, is again important from this point of view.

As a further condition, autonomous operation of the vehicle only takes place if a radius of curvature of the driving lane of the vehicle is greater than a predefined limit value G1, whereby it is ensured that too large curve radii do not occur during autonomous operation of the vehicle.

As a further condition, autonomous operation of the vehicle only takes place if the travel path has no humps or dips that substantially limit the range of environmental detection sensors, for example a camera or radar system, i.e., limit to such an extent that a predetermined minimum range is fallen below.

As a further condition, there must be no traffic disruptions or traffic reports about dangerous situations because, in such situations, traffic-dependent action can often not be outlined with predefined routines. Information about traffic disruptions or traffic reports about dangerous situations is directly relevant to decision making and is preferably able to be transmitted to the respective vehicle via telematics services.

A first preferred embodiment of the method according to the invention provides for the autonomous operation of the vehicle to be linked to further conditions. First, a condition that autonomous operation of the vehicle should only be possible when a current position of the vehicle is determined in the vehicle with position accuracy better than a predetermined limit value G2 can be employed. This ensures an accurate location possibility of the vehicle on a driving lane is provided that is essential for autonomous operation of the vehicle.

As a further condition autonomous operation of the vehicle may only take place if digital map data about the course of the travel path are present for the predetermined route length of the driving route ahead having a position accuracy better than a predetermined limit value G3, whereby it is ensured that, when using digital map data to calculate a vehicle trajectory along the predetermined driving route ahead, sufficiently precise map material is present which, in particular, also comprises a digital image of the driving lanes of the driving route ahead.

As a further condition for autonomous operation of the vehicle there must be a connection to a server via which current traffic information, preferably information about local hazard points such as, for example, roadworks, can be provided for the driving route ahead of the vehicle.

As a further a condition all systems of the vehicle required for autonomous operation of the vehicle must operate without errors. For this purpose, a standardised search can preferably be carried out via a control unit which is also designed for implementing a method for the autonomous operation of the vehicle.

As a further condition the weather conditions for the driving route ahead must correspond to predetermined minimum weather conditions. Here, it is preferably expedient to predefine such minimum weather conditions that guarantee an undisturbed operation of the assistance systems that are necessary for the autonomous operation of the vehicle, in particular of such systems which are formed as optical assistance systems.

Finally, as a further condition for autonomous operation of the vehicle surface conditions corresponding to predetermined minimum surface conditions must be present for the driving route ahead. This ensures autonomous operation of the vehicle is not possible when there are reduced surface friction values plow or suddenly changing surface friction values μjump, such as those occurring particularly in autumn or winter.

A further embodiment of the method according to the invention provides, if autonomous operation of the vehicle is permitted, to signal this to a driver of the vehicle. Signalling is preferably carried out visually, for example by displaying a corresponding message in a combination instrument and/or in a central display and/or additionally in a head-up display, as well as acoustically, preferably by issuing a corresponding signal tone and/or a spoken message.

In addition, the predetermined route length is selected from a range [1 km, . . . , 2 km, . . . , 3 km, . . . , 4 km, . . . , 5 km, . . . , 10 km, . . . , 20 km].

If the corresponding conditions for this route length are present, autonomous operation of the vehicle is possible.

A further development of the method involves the digital map data comprising several layers, wherein one of the layers contains data relating to lane courses of the individual driving lanes of the travel path, and a further layer contains data relating to objects arranged along the driving lanes. The term “layer” is understood here as a data plane or as a separated or individually addressable volumes of data. Corresponding objects are, for example, bridges, tunnels, toll stations, junctions and holding stations. A corresponding layer structure ensures that the digital map material provides sufficiently accurate information, on the basis of which a decision can be made about the possibility of autonomous operation of the vehicle based on secure information.

Furthermore, exemplary embodiments are further directed to an assistance system for the autonomous operation of a vehicle on a driving route ahead by a control unit being present that only permits the autonomous operation of the vehicle if at least one of the following conditions is fulfilled for a predetermined route length of the driving route ahead.

An exemplary condition is to only permit the autonomous operation of the vehicle if a structural separation, for example a crash barrier or guide wall, is present on one side, preferably on both sides of a current travel path of the vehicle. This aspect limits the use of autonomous operation of the vehicle to motorways and mostly highways developed with multiple lanes.

As a further condition, autonomous operation of the vehicle is only permitted when a driving lane of the vehicle has a minimum lane width, whereby it is ensured that minimum distance tolerances to adjacent driving lanes can also be adhered to during autonomous operation of the vehicle.

As a further condition, the number of driving lanes must not change during autonomous operation. In this way, hazardous points such as local lane merging areas or roadworks are specifically exempt from autonomous operation of the vehicle.

As a further condition, there must be no tunnel present for autonomous operation of the vehicle because even a tunnel is a local hazard point and, in addition, not all systems required for autonomous operation of the vehicle are available in a tunnel, wherein this aspect is particularly applicable to telematics-based systems, in particular for data transmissions to backend systems.

As a further condition, autonomous operation of the vehicle should only be possible if no building such as a toll station, for example, is present on the road, since these infrastructural facilities are also local hazard points.

As a further condition, autonomous operation of the vehicle must be stopped when a motorway junction is present, wherein the aspect of a local hazard point, along with a change in the number of driving lanes, is again important from this point of view.

As a further condition, autonomous operation of the vehicle only takes place if a radius of curvature of the driving lane of the vehicle is greater than a predefined limit value G1, whereby it is ensured that too large curve radii do not occur during autonomous operation of the vehicle.

As a further condition, there must be no traffic disruptions or traffic reports about dangerous situations because, in such situations, traffic-dependent action can often not be outlined with predefined routines. Information about traffic disruptions or traffic reports about dangerous situations is directly relevant to decision making and is preferably able to be transmitted to the respective vehicle via telematics services.

As a further condition, autonomous operation of the vehicle only takes place if the travel path has no humps or dips that substantially limit the range of environmental detection sensors.

A preferred embodiment of the assistance system according to the invention provides that the control unit links the autonomous operation of the vehicle to further conditions.

First, a condition that autonomous operation of the vehicle should only be possible when a current position of the vehicle is determined in the vehicle with position accuracy better than a predetermined limit value G2. This ensures an accurate location possibility of the vehicle on a driving lane is provided that is essential for autonomous operation of the vehicle.

As a further condition autonomous operation of the vehicle may only take place if digital map data about the course of the travel path are present for the predetermined route length of the driving route ahead having a position accuracy which is better than a predetermined limit value G3, whereby it is ensured that, when using digital map data to calculate a vehicle trajectory along the predetermined driving route ahead, sufficiently precise map material is present which, in particular, also comprises a digital image of the driving lanes of the driving route ahead.

As a further condition for autonomous operation of the vehicle there must be a connection to a server via which current traffic information, preferably information about local hazard points such as, for example, roadworks, can be provided for the driving route ahead of the vehicle.

As a further condition all systems of the vehicle required for autonomous operation of the vehicle must operate without errors. For this purpose, a standardized search can preferably be carried out via a control unit that is also designed for implementing a method for the autonomous operation of the vehicle.

As a further condition the weather conditions for the driving route ahead must correspond to predetermined minimum weather conditions. Here, it is preferably expedient to predefine such minimum weather conditions that guarantee an undisturbed operation of the assistance systems that are necessary for the autonomous operation of the vehicle, in particular of such systems which are formed as optical assistance systems.

Finally, as a further condition for autonomous operation of the vehicle surface conditions corresponding to predetermined minimum surface conditions must be present for the driving route ahead. This ensures autonomous operation of the vehicle is not possible when there are reduced surface friction values plow or suddenly changing surface friction values μjump, such as those occurring particularly in autumn or winter.

In a further embodiment of the assistance system according to the invention, the assistance system comprises an output means formed and arranged in such a way that an activation capability of the assistance system can be signalled to a driver of the vehicle via the display means. Signalling is preferably carried out visually, for example by displaying a corresponding message in a combination instrument and/or in a central display and/or additionally in a head-up display, as well as acoustically, preferably by issuing a corresponding signal tone and/or a spoken message.

The invention finally relates to a vehicle comprising an assistance system described above.

Further advantages, features and details arise from the following description in which at least one exemplary embodiment is described in detail, if applicable with reference to the drawing. The same, similar and/or functionally identical parts are referred to with the same reference numerals.

### BRIEF DESCRIPTION OF THE DRAWING FIGURES

Here are shown:

FIG. 1 a traffic situation with a vehicle on a driving lane and a driving route ahead, and

FIG. 2 an assistance system according to the invention for carrying out a method according to the invention.

### DETAILED DESCRIPTION

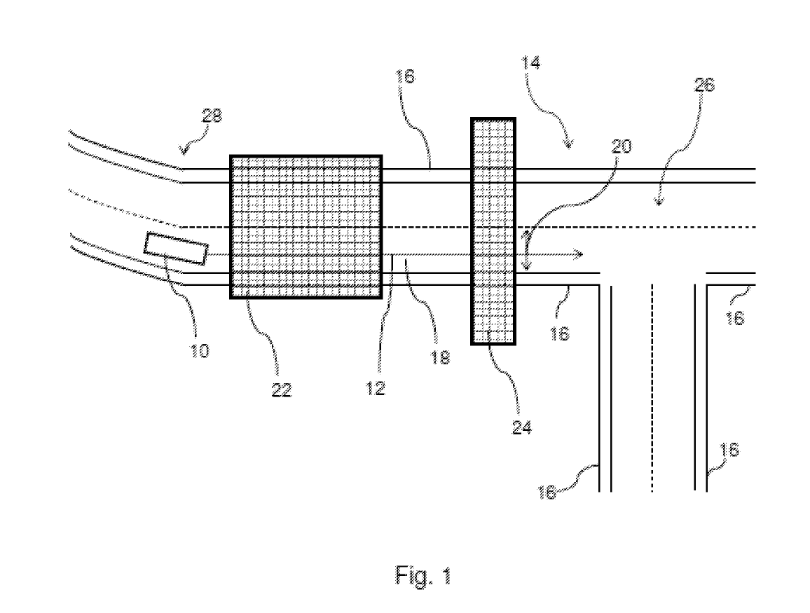

FIG. 1 shows a traffic situation with a vehicle 10 on a travel path 14 with two driving lanes 18. In front of the vehicle 10, there is a driving route 12 ahead that can only be covered by the vehicle 10 in autonomous operation 46 when one or a group of the conditions described below, preferably all the conditions, have been fulfilled.

Condition 1: there must be a structural separation, for example in the form of crash barriers or guide walls 16, on at least one side, preferably on the side of the travel path of oncoming traffic, optionally also on both sides of the current travel path 14 of the vehicle 10,

Condition 2: the driving lane 18 of the vehicle 10 must have a predetermined minimum lane width 20,

Condition 3: the radius of curvature 28 of the driving route 12 must not fall below a predetermined limit value G1, whereby too tight curve radii, which could impair an autonomous operation 46 of the vehicle 10 in a dangerous manner, should be avoided on the driving route 10 ahead,

Condition 4: the range of environmental detection sensors, for example a radar or camera system, is not substantially limited by humps or dips, i.e., the range is not limited to a value which is below a predetermined minimum range,

Condition 5: the number of driving lanes 18 must not change on the driving route 12 ahead,

Condition 6: no tunnel 22 and no building 24, such as a toll station, for example, may be present on the driving route 12,

Condition 7: there must not be a motorway junction 26 on the driving route 12 ahead of the vehicle 10,

Condition 8: there must not be any traffic disruptions, for example slow-moving traffic,

Condition 9: there must not be any traffic reports about dangerous situations, which can be retrieved via an external server,

Conditions 5 to 9 are preferably optional conditions, i.e. they are preferably only considered in combination with at least one of conditions 1 to 4.

In the situation shown in FIG. 1, only conditions 2, 3 and 6 are fulfilled for the driving route 12, such that autonomous operation of the vehicle 10 is not possible.

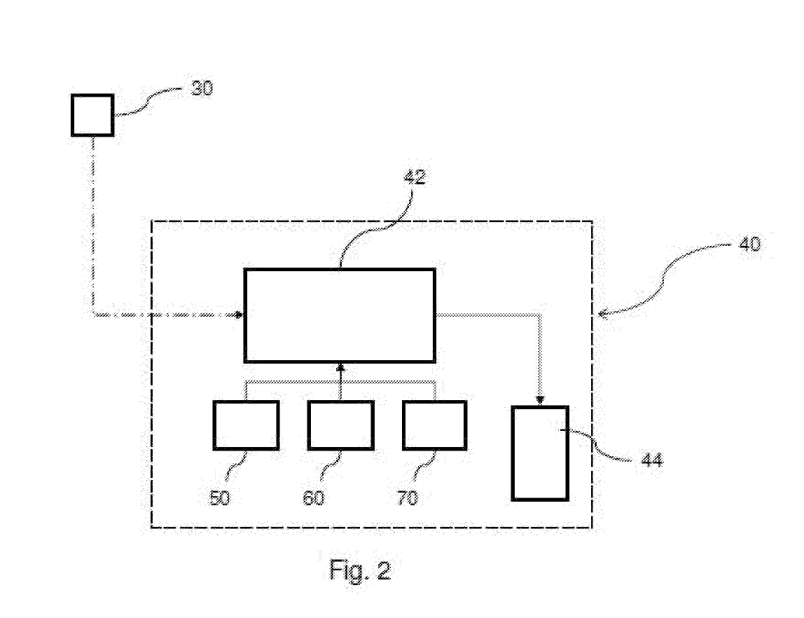

FIG. 2 depicts an assistance system 40 for the autonomous operation of a vehicle 10. The assistance system 40 comprises a control unit 42, an output means 44, a sensor system 50, a navigation database 60, and a position detection system 70, for example a GPS receiver. The control unit 42 also receives traffic information and weather information from a central server 30 via a mobile network. The sensor system 50 scans the vehicle environment and detected current environmental information, for example about the presence of crash barriers, the radius of curvature of the driving route ahead, the number of driving lanes, the presence of tunnels, buildings and motorway junctions. The navigation database 60 maintains a digital road map with at least one piece of the information cited above.

In the present case, the control unit 42 is designed and configured in such a way that autonomous operation of the vehicle is only enabled if at least one or all or a group of the conditions described below have been fulfilled. First, a structural separation 16 must be present on one of the two sides of the current travel path 14 of the vehicle 10, preferably on the side of the travel path of the oncoming traffic, or on both sides; furthermore the driving lane 18 of the vehicle 10 must have a minimum width 20, in addition, the number of driving lanes 18 in the driving route 12 ahead must not change. Furthermore, no tunnel 22 and no building 24, such as a toll station, for example, may be present on the driving route 12; in addition, there must be no motorway junction 26 on the driving route 12 ahead of the vehicle 10. Finally, a radius of curvature 28 of the driving route 12 must not fall below a predetermined limit value G1.

Although the invention has been illustrated and explained in more detail by preferred exemplary embodiments, the invention is not limited by the examples disclosed and other variations may be derived therefrom by the person skilled in the art without leaving the scope of the invention. It is therefore clear that there is a plurality of possible variations. It is also clear that embodiments stated by way of example are only really examples which are not to be seen as limiting the scope, application possibilities or configuration of the invention in any way. In fact, the preceding description and the description of the figures enable the person skilled in the art to implement the exemplary embodiments in a concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for autonomous operation of a vehicle on a driving route ahead, the method comprising:
determining whether one predetermined condition or a group of predetermined conditions is/are fulfilled for a predetermined route length of the driving route ahead; and
permitting the autonomous operation of the vehicle only if the one predetermined condition or the group of predetermined conditions is/are fulfilled for a predetermined route length of the driving route ahead,
wherein the one predetermined condition or the group of predetermined conditions include:
there is a structural separation on at least one side of a current travel path of the vehicle,
there are no humps and dips substantially limiting the range of environmental detection sensors, and
there are no tunnels.

11. The method of claim 10, wherein the one predetermined condition or the group of predetermined conditions further include:
a driving lane of the vehicle has a minimum lane width,
a radius of curvature of the driving lane of the vehicle is larger than a predetermined limit value,
a number of driving lanes does not change,
there are no buildings on the current travel path,
there are no motorway junctions,
there are no traffic disruptions,
there are no traffic reports about dangerous situations, and
there are no reports about presence of roadworks.

12. The method of claim 10, wherein the autonomous operation of the vehicle is only permitted if one following conditions or a group of the following conditions is/are fulfilled for a predetermined route length of the driving route ahead:
a current position of the vehicle is determined in the vehicle with a position accuracy better than a predetermined limit value G2,
digital map data about a course of the current travel path are present for the predetermined route length of the driving route ahead, the digital map data having a position accuracy better than a predetermined limit value G3,
there is a connection to a server, by means of which current traffic information for the driving route ahead can be provided,
all systems of the vehicle required for autonomous operation operate without errors.

13. The method of claim 10, wherein if the autonomous operation is permitted, the vehicle generates an output that signal that the autonomous operation is permitted.

14. The method of claim 10, wherein the predetermined route length ranges from 1 km to 20 km.

15. The method of claim 12, wherein the digital map data comprise two layers, wherein data relating to the lane courses of the driving lanes are provided in one of the layers and data relating to objects arranged along the driving lanes are provided in the other of the two layers.

16. An assistance system for autonomous operation of a vehicle on a driving route ahead, the system comprising:
a control unit configured to only permit the autonomous operation of the vehicle if one predetermined condition or a group of predetermined conditions is/are fulfilled for a predetermined route length of the driving route ahead,
wherein the one predetermined condition or the group of predetermined conditions include:
there is a structural separation on at least one side of a current travel path of the vehicle,
there are no humps and dips substantially limiting the range of environmental detection sensors, and
there are no tunnels.

17. The assistance system of claim 16, the predetermined condition or the group of predetermined conditions further include:
a driving lane of the vehicle has a minimum lane width,
the number of driving lanes does not change,
there are no buildings on the current travel path,
there are no motorway junctions,
a radius of curvature of the driving lane of the vehicle is larger than a predetermined limit value G1,
there are no traffic disruptions,
there are no traffic reports about dangerous situations, and
there are no reports about the presence of roadworks.

18. The assistance system of claim 16, wherein the control unit only permits the autonomous operation of the vehicle if one or a group of the following conditions is/are fulfilled for a predetermined route length of the driving route ahead:
a current position of the vehicle is determined in the vehicle with a position accuracy better than a predetermined limit value G2,
digital map data about a course of the current travel path are present for the predetermined route length of the driving route ahead, the digital map data having a position accuracy better than a predetermined limit value G3,
there is a connection to a server, by means of which current traffic information for the driving route ahead can be provided,
all systems of the vehicle required for autonomous operation operate without errors,
weather conditions for the driving route ahead meet predetermined minimum weather conditions,
surface conditions of the travel path of the driving route ahead meet predetermined minimum surface conditions.

19. A vehicle comprising the assistance system of claim 16.
